(19) United States
(12) Patent Application Publication
(10) Pub. No.: US 2021/0310859 A1
(43) Pub. Date: Oct. 7, 2021

(54) LIGHT AMOUNT MEASUREMENT DEVICE AND CONTROL METHOD THEREFOR

(71) Applicant: CANON KABUSHIKI KAISHA, Tokyo (JP)

(72) Inventors: Takehito Fukushima, Tokyo (JP); Hironobu Hoshino, Tokyo (JP)

(21) Appl. No.: 17/221,372

(22) Filed: Apr. 2, 2021

(30) Foreign Application Priority Data
Apr. 6, 2020 (JP) 2020-068474

(51) Int. Cl. G01J 1/04; G01J 1/18; G01J 1/08

(52) U.S. Cl. CPC G01J 1/0437; G01J 2001/086; G01J 2001/186; G01J 1/0488

(57) ABSTRACT

A light amount measurement device includes: a light source unit including a light source; a display unit including a transmissive panel that transmits light emitted from the light source; a light reception unit configured to measure an amount of light that has passed through the display unit; and a control unit configured to control, during calibration of the display unit, a brightness measured by the light reception unit to a higher brightness than an ideal brightness corresponding to a measurement gradation, by either increasing the light amount emitted by the light source or increasing a transmittance of the display unit.

### BACKGROUND OF THE INVENTION

### Field of the Invention

The present invention relates to alight amount measurement device for a transmissive display, and a control method for the light amount measurement device.

### Description of the Related Art

In recent years, in various applications, such as video production, creation of an original for printing or plate making, photo retouching, and medical image viewing, display devices, such as liquid crystal displays, require high-precision brightness and color reproduction. In such display devices, calibration processing, known as calibration, is performed in order to maintain the precision of the display.

A spectroscopic measurement instrument may be used in calibration processing in order to measure the characteristics of a display device with a high degree of precision. A spectroscopic measurement instrument is capable of measuring the characteristics of a display device with a high degree of precision, however, at low brightness, the measurement time tends to be long.

To solve this problem, calibration techniques for shortening the measurement time have been disclosed. Japanese Patent Application Publication No. 2015-121507, for example, discloses a method for shortening the measurement time during calibration by increasing the brightness of a backlight (also referred to hereafter as a light source) and the transmittance of the liquid crystal.

However, the display device is measured a total of three times, namely in a pattern for increasing the light source brightness, a pattern for increasing the liquid crystal transmittance, and a pattern for increasing both, and therefore a sufficient effect in terms of shortening the measurement time cannot be acquired.

### SUMMARY OF THE INVENTION

The present invention provides a light amount measurement device and a control method therefor, with which the measurement time at low brightness can be shortened during calibration processing of a display device.

A light amount measurement device according to the present invention includes: a light source unit including a light source; a display unit including a transmissive panel that transmits light emitted from the light source; a light reception unit configured to measure an amount of light that has passed through the display unit; and a control unit configured to control, during calibration of the display unit, a brightness measured by the light reception unit to a higher brightness than an ideal brightness corresponding to a measurement gradation, by either increasing the light amount emitted by the light source or increasing a transmittance of the display unit.

Further features of the present invention will become apparent from the following description of exemplary embodiments with reference to the attached drawings.

### BRIEF DESCRIPTION OF THE DRAWINGS

FIG. 1 is a block diagram showing an example configuration of a light amount measurement device;

FIG. 2 is a view showing an example of a measurement image;

FIGS. 3A to 3D are views illustrating data stored in a storage unit;

FIG. 4 is a flowchart showing an example of light amount measurement processing according to a first embodiment;

FIG. 5 is a flowchart showing an example of light amount measurement processing according to a second embodiment;

FIG. 6 is an example display of an estimated calibration end time according to the second embodiment;

FIGS. 7A and 7B are views illustrating data stored in a storage unit according to the second embodiment;

FIG. 8 is a block diagram showing an example configuration of a light amount measurement device according to a third embodiment;

FIG. 9 is a flowchart showing an example of light amount measurement processing according to the third embodiment;

FIGS. 10A and 10B are views showing examples of light source unit temperatures according to measurement gradation number:

FIGS. 11A to 11C are views illustrating lighting of the light source and an effect of responsiveness thereon;

FIG. 12 is a flowchart showing an example of light amount measurement processing according to modified example 2; and

FIGS. 13A and 13B are views illustrating a relationship between lighting of the light source and the measurement time.

### DESCRIPTION OF THE EMBODIMENTS

### First Embodiment

### Device Configuration

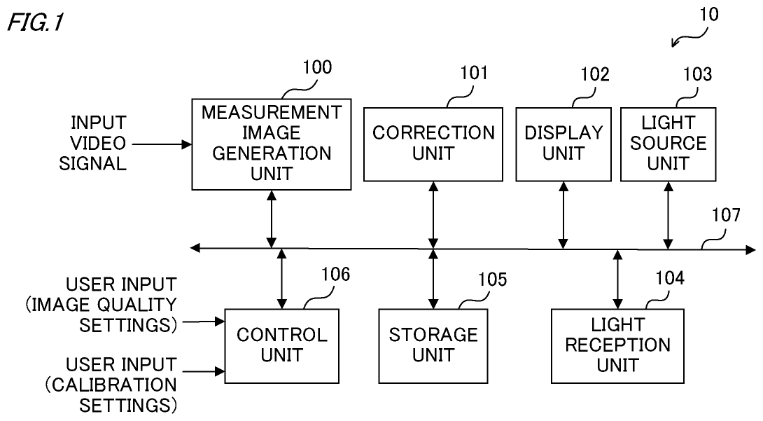

Preferred embodiments of the present invention will be described below with reference to the figures. FIG. 1 is a block diagram showing an example configuration of a light amount measurement device 10.

The light amount measurement device 10 according to the present invention includes a measurement image generation unit 100, a correction unit 101, a display unit 102, a light source unit 103, a light reception unit 104, a storage unit 105, and a control unit 106. The respective units of the light amount measurement device 10 are connected to each other by a bus 107 through which various signals flow.

When calibration processing (also referred to hereafter as calibration) is performed on a display device, the measurement image generation unit 100 generates a measurement image in accordance with a measurement gradation and an area ratio relative to a display screen, which are determined in advance. The measurement image generation unit 100 receives an instruction indicating whether or not to implement calibration from the control unit 106. When calibration is to be implemented, the measurement image generation unit 100 acquires the measurement gradation and the area ratio relative to the display screen from the control unit 106.

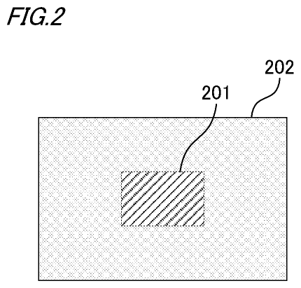

Referring to FIG. 2, the measurement image will be described. FIG. 2 is a view showing an example of the measurement image. In the example of FIG. 2, the measurement image generation unit 100 acquires 4095 (12 bits) as a measurement gradation value and 10% as the area ratio relative to the display screen from the control unit 106. In this case, as shown in FIG. 2, the measurement image generation unit 100 generates a measurement image displaying a patch 201 with a gradation value of 4095 and an area ratio of 10% based on the center of the screen, and a background 202 with a gradation value of 0. Note that the gradation value of the background 202 is not limited to 0 and may be any gradation value smaller than 4095.

When calibration is to be implemented, the measurement image generation unit 100 outputs the generated measurement image to the correction unit 101 in the form of a video signal. When calibration is not to be implemented, on the other hand, the measurement image generation unit 100 outputs an input video signal received from an external device to the correction unit 101 in the form of a video signal.

The correction unit 101 implements a correction such as gamma correction or color correction on the video signal output by the measurement image generation unit 100. In the following description, it is assumed that the correction performed by the correction unit 101 is gamma correction.

When the correction unit 101 implements gamma correction on the video signal, the correction unit 101 uses a correction table stored in advance in the storage unit 105. The correction unit 101 looks up (refers to) the correction table in order to generate a corrected video signal on the basis of the gradation value of the video signal. The correction unit 101 then outputs the generated corrected video signal to the display unit 102. The correction applied to the video signal is not limited to being looked up on a correction table and may be determined by calculation. Further, the correction table may be generated during the calibration processing.

The display unit 102 displays the corrected video signal output from the correction unit 101. A transmissive panel having a transmittance that can be modified in accordance with the corrected video signal is mounted on the display unit 102.

The light source unit 103 includes a light source for illuminating the video displayed on the display unit 102. The light source unit 103 controls the light amount emitted by the light source in accordance with a pulse width modulation (PWM hereafter) generated by the control unit 106. The light reception unit 104 measures the brightness and color of the display unit 102.

The storage unit 105 is a recording medium for storing a correction value and information relating to the correction, and is constituted by a semiconductor memory, an optical disk, a magnetic disk, or the like. More specifically, the storage unit 105 stores the correction table used for the gamma correction, measurement gradations and ideal brightnesses using during the calibration processing, measurement times corresponding to the type of sensor used by the light reception unit 104, stabilization times corresponding to the brightness, and so on.

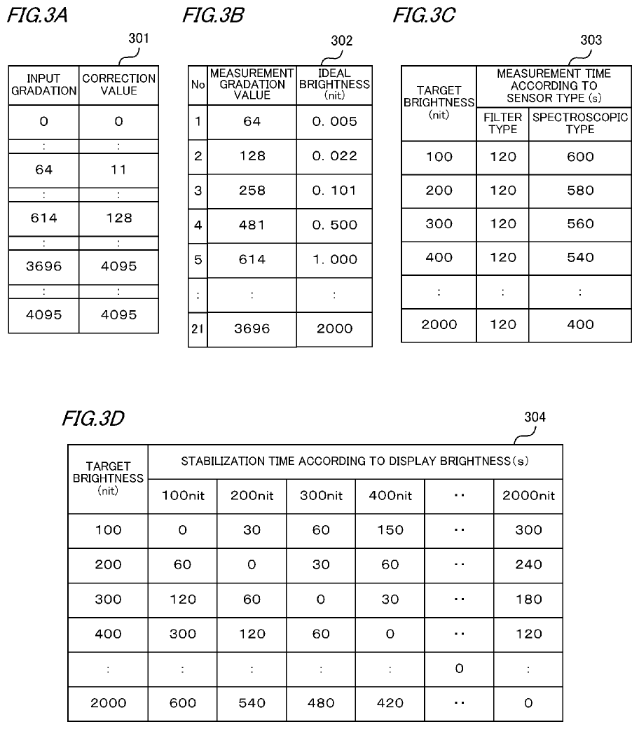

Referring to FIGS. 3A to 3D, the data stored in the storage unit 105 will be described. FIGS. 3A to 3D are views illustrating the data stored in the storage unit. In FIGS. 3A to 3D, the data stored in the storage unit 105 are shown in a table format.

FIG. 3A shows an example of a correction table 301 used for the gamma correction. On the correction table 301, correction values are associated respectively with input gradation values. The storage unit 105 may store the correction table 301 for each type of gamma correction. Types of gamma correction include, for example, gamma 2.2 based on the BT.709 standard, the hybrid log gamma (HLG) method, which is a gamma method based on the BT.2100 standard, the perceptual quantization (PQ, ST2084) method, and so on.

The correction unit 101 selects and acquires the correction table 301 corresponding to a gamma setting input by a user from the storage unit 105. Further, an area for storing a gamma correction table created from a measurement result acquired during the calibration processing is preferably secured in advance in the storage unit 105.

FIG. 3B shows an example of an ideal brightness table 302 on which measurement gradations used during the calibration processing are respectively associated with ideal brightnesses. On the ideal brightness table 302, a measurement gradation value corresponding to a measurement gradation number N is associated with an ideal brightness when that gradation is displayed. The storage unit 105 stores the ideal brightness table 302 for each type of gamma correction. The control unit 106 selects and acquires the ideal brightness table 302 corresponding to the gamma setting input by the user.

FIG. 3C shows an example of a measurement time table 303 on which target brightnesses of the calibration are respectively associated with measurement times corresponding to the type of sensor used by the light reception unit 104. The target brightness is a target value of the brightness, which is set by the user when implementing calibration. The user can implement a calibration for each target brightness.

Types of sensors include, for example, a filter type sensor, a spectroscopic sensor, and so on. The measurement time table 303 stores target brightnesses of the calibration and estimated measurement times corresponding to the type of sensor. The control unit 106 acquires the estimated measurement time from the measurement time table 303 in accordance with the target brightness and sensor information (the type of sensor), which are included in calibration settings input by the user.

FIG. 3D shows an example of a stabilization time table 304 on which estimated times to measurement stabilization are stored in accordance with the target brightness of the calibration and the current display brightness. The estimated time to measurement stabilization is the time (also referred to hereafter as the stabilization time) for the display on the display unit 102 and light emission by the light source to stabilize. The control unit 106 can acquire the stabilization time from the stabilization time table 304 when the current display brightness is switched to the target brightness included in the calibration settings input by the user.

The control unit 106 controls the respective units on the basis of the calibration settings and image quality settings input by the user. The calibration settings include target image quality values such as brightness, gamma, color temperature, color gamut, and local dimming, and also settings such as the type of sensor used by the light reception unit 104. Note that the image quality settings and calibration settings are not limited to being input by the user and may take preset values. When calibration is started, the control unit 106 causes the measurement image generation unit 100 to generate a measurement image on the basis of the target image quality values. The measurement image generation unit 100 outputs the generated measurement image to the correction unit 101.

For example, when local dimming for controlling the luminosity of the backlight is OFF, the control unit 106 instructs the measurement image generation unit 100 to display the measurement gradation value over the whole screen. In a case where local dimming is ON, the control unit 106 instructs the measurement image generation unit 100 to display the measurement gradation value at the instructed area ratio.

In a case where the gamma setting included in the calibration settings is PQ, the control unit 106 acquires the PQ correction table from the storage unit 105 and transfers the acquired table to the correction unit 101. The correction unit 101 refers to the transferred PQ correction table and outputs a video signal corrected in accordance with the gradation value of the video signal to the display unit 102. Further, the control unit 106 generates a PWM in accordance with the correction video signal and outputs the generated PWM to the light source unit 103.

By defining PWMs of a maximum gradation and a minimum gradation in advance, the control unit 106 can determine PWMs of intermediate gradations by linear interpolation. PWMs may also be generated by storing values corresponding respectively to gradation values in advance on a table in the storage unit 105 or the like.

For example, when local dimming is OFF, the control unit 106 generates a PWM on the basis of a mean gradation value of the corrected video signal. Further, when local dimming is ON, the control unit 106 generates separate PWMs for the patch 201 and the background 202 shown in FIG. 2. Here, the generated PWM indicates a light amount at which to realize the ideal brightness for the gradation value of the corrected video signal output from the correction unit 101. The ideal brightness is a brightness conforming to the standard.

The display unit 102 and the light source unit 103 deviate from the standard due to aging and temperature, and are therefore corrected by calibration. After the display unit 102 displays the corrected video signal, the control unit 106 transmits an instruction to the light reception unit 104 to measure the current display brightness and chromaticity. In response to the instruction from the control unit 106, the light reception unit 104 repeatedly measures the brightness and chromaticity and outputs measurement results to the control unit 106. The control unit 106 calculates a correction value from the measurement results and stores the calculated correction value in the storage unit 105.

In a case where the target brightness included in the calibration settings is 2000 nit and the gamma setting is PQ, from the correction table 301 shown in FIG. 3A, the gradation value (the correction value) of a corrected video signal for an input gradation value of 64 is 11. When a corrected signal with a gradation value of 11 is displayed on the display unit 102, the ideal brightness of 0.005. When the actually measured brightness is 0.006, this is 0.001 higher than the ideal brightness, and therefore the correction value of the measurement gradation value 64 should be set at not more than 10. When a state of low brightness is measured, depending on the type of sensor used by the light reception unit 104, the measurement time may increase. In a first embodiment to be described below, a method for shortening the measurement time will be described.

When calibration is complete, the correction unit 101 corrects the video signal by referring to the correction table created during the calibration and displays the corrected video on the display unit 102.

### Light Amount Measurement Processing

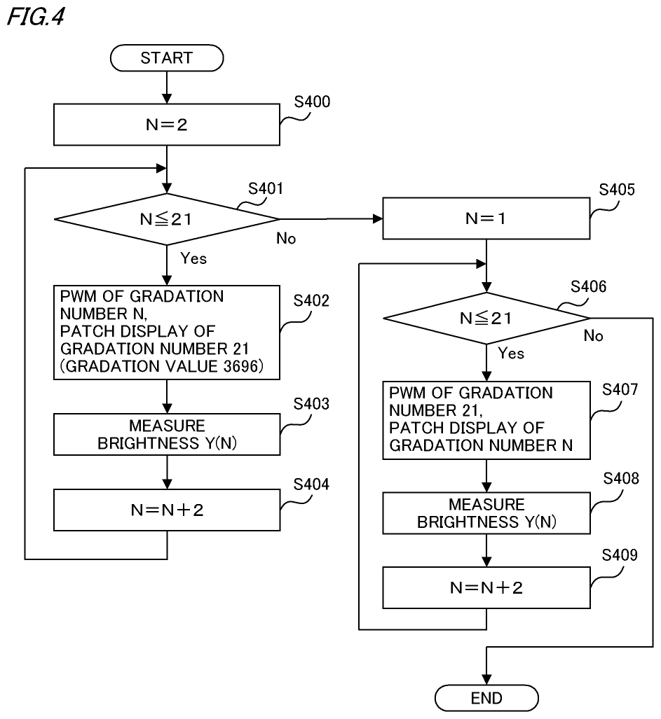

Light amount measurement processing according to the first embodiment will be described below with reference to FIGS. 1 and 4. FIG. 4 is a flowchart showing an example of the light amount measurement processing according to the first embodiment. In the first embodiment, the gamma setting included in the calibration settings is assumed to be PQ, and the processing will be described using the ideal brightnesses of the plurality of measurement gradations (measurement gradation numbers N=1 to 21) shown in FIG. 3B. The local dimming setting is assumed to be ON. It is assumed, as a prerequisite, that the display unit 102 displays a patch having an area ratio of 10% relative to the display screen, and the light reception unit 104 measures the brightness. Hereafter, the brightness at the measurement gradation number N will be described as a brightness Y(N).

In S400, the control unit 106 acquires the ideal brightness table 302, on which ideal brightnesses are stored in relation to measurement gradation numbers N, from the storage unit 105. The control unit 106 then starts measurement at the measurement gradation number N=2. The control unit 106 implements the measurement processing in relation to the plurality of measurement gradations by executing S401 to S404 when the measurement gradation number N is an even number and executing S406 to S409 when the measurement gradation number N is an odd number.

In S401, the control unit 106 determines whether the measurement gradation number N is not larger than 21. In a case where the measurement gradation number N is not larger than 21, the processing advances to S402, and when the measurement gradation number N is larger than 21, the processing advances to S405.

In S402, the light source unit 103 emits light at a light amount (a PWM) at which the ideal brightness for the measurement gradation value of the measurement gradation number N is realized. Meanwhile, the display unit 102 displays the gradation of the actually displayed patch 201 as 36%, which is the measurement gradation value of the measurement gradation number 21. In other words, when the measurement gradation number N is even, the control unit 106 fixes the transmittance of the display unit 102 at the transmittance of the maximum measurement gradation, and then measures variation in the light amount emitted by the light source unit 103.

In S403, the control unit 106 instructs the light reception unit 104 to measure the brightness Y(N). As described in S402, measurement can be performed at a high brightness by increasing the transmittance of the display unit 102, and as a result, the measurement time taken by the light reception unit 104 is shortened. The light reception unit 104 outputs the brightness Y(N) acquired as the measurement result to the control unit 106.

In S404, the control unit 106 sets the measurement gradation number N at N+2 by adding 2 to N in order to perform a measurement at the next even-numbered gradation of the measurement gradation numbers N. The processing then returns to S401. The control unit 106 implements measurements by repeating the processing of S401 to S404 until measurements have been completed at the even-numbered gradations among 21 gradations.

In S405, the control unit 106 sets the measurement gradation number N at N=1 and starts measurement for cases in which the measurement gradation number N is odd.

In S406, the control unit 106 determines whether or not the measurement gradation number N is not larger than 21. In a case where the measurement gradation number N is not larger than 21, the processing advances to S407, and when the measurement gradation number N is larger than 21, the processing shown in FIG. 4 is terminated.

In S407, the control unit 106 lights the light source unit 103 at the light amount (the PWM) at which the ideal brightness for the measurement gradation value 3696 of the measurement gradation number 21 is realized. Note that as a result of the processing of S401 to S404, the light amount (the PWM) of the light source is set at a light amount corresponding to measurement gradation number=20. The PWM increases in accordance with the measurement gradation number N, or in other words the measurement gradation value, and therefore switching of the PWM in S407 is achieved smoothly.

The display unit 102 displays the patch 201 at the measurement gradation value corresponding to the measurement gradation number N. In other words, when the measurement gradation number N is odd, the control unit 106 fixes the light amount of the light source unit 103 at the light amount corresponding to the maximum measurement gradation, and then measures the transmittance of the display unit 102.

In S408, the control unit 106 instructs the light reception unit 104 to measure the brightness Y(N). As described in S407, measurement can be performed at a high brightness by increasing the light amount emitted by the light source unit 103, and as a result, the measurement time taken by the light reception unit 104 is shortened. The light reception unit 104 outputs the brightness Y(N) acquired as the measurement result to the control unit 106.

In S409, the control unit 106 sets the measurement gradation number N at N+2 by adding 2 to N in order to perform a measurement at the next odd-numbered gradation of the measurement gradation numbers N. The processing then returns to S406. The control unit 106 implements measurements by repeating the processing of S406 to S409 until measurements have been completed at the odd-numbered gradations among the 21 gradations. By first implementing a measurement after fixing the transmittance of the display unit 102 and varying the intensity of the backlight and then fixing the light amount (intensity) of the light source and varying the transmittance of the display unit 102, as shown in FIG. 4, measurement can be performed efficiently.

The brightness Y(N) acquired as a result of the measurement processing of FIG. 4 is a higher brightness than when the transmittance of the display unit 102 and the light amount emitted by the light source unit 103 are not controlled. In other words, the brightness Y(N) acquired as a result of the measurement has a higher brightness value than the ideal brightness at the corresponding gradation, which is acquired from the target value set during calibration. Hence, the post-calibration correction table is determined by converting the acquired brightness Y(N).

In the example of FIG. 4, the display unit 102 and the light source unit 103 are controlled by different methods depending on whether the measurement gradation number N is even or odd, and therefore the acquired brightness Y(N) is converted separately in accordance with whether the measurement gradation number N is even or odd. A converted brightness Ym(N) is calculated as follows.

(1) In a case where N is Even
Ym(N)={Y(N)×Yr(N)×PWM(21)}/{Yr(21)×PWM(N)}
Yr(N): ideal brightness for measurement gradation number N
   (2) In a case where N is Odd
Ym(N)=Y(N)×{PWM(N)/PWM(21)}

The control unit 106 can generate the correction table from the difference between the converted brightness Ym(N) and the ideal brightness Yr(N).

An example in which measurement is performed in a state of higher brightness than the ideal brightness by respectively fixing the transmittance of the display unit 102 and the light amount emitted by the light source unit 103 at the transmittance and the light amount corresponding to the maximum measurement gradation was illustrated above, but the present invention is not limited thereto. Instead, measurement may be performed by setting both the transmittance of the display unit 102 and the light amount emitted by the light source unit 103 at a transmittance and a light amount corresponding to a larger gradation than the measurement gradation.

Further, during measurement at a higher brightness than the ideal brightness, the control unit 106 may skip (i.e., not perform) measurements at measurement gradations at which it is determined that a deviation between the measured brightness and the ideal brightness is not higher than a predetermined threshold. The deviation between the measured brightness and the ideal brightness decreases as the ideal brightness increases. Therefore, whether the deviation between the measured brightness and the ideal brightness is not higher than the predetermined threshold may be determined by determining whether the ideal brightness is at least 300 nit, for example.

Furthermore, measurement at a higher brightness than the ideal brightness may be applied only in cases where measurement is performed at low brightness. Whether or not the brightness is low may be determined according to the ideal brightness, for example when the ideal brightness is not more than 1 nit or the like, or according to whether the actual brightness or the measurement gradation is not higher than a predetermined threshold.

According to the light amount measurement device 10 of this embodiment, measurement can be performed at a high brightness value, and as a result, the measurement time for calibration can be shortened.

### Second Embodiment

In a second embodiment, the light amount measurement device 10 infers the time for calibration and notifies the user thereof. The light amount measurement device 10 can notify the user of the inferred time at the start of calibration, for example.

The light amount measurement device according to the second embodiment is configured similarly to the light amount measurement device 10 according to the first embodiment, shown in FIG. 1, and therefore description thereof has been omitted.

### Light Amount Measurement Processing

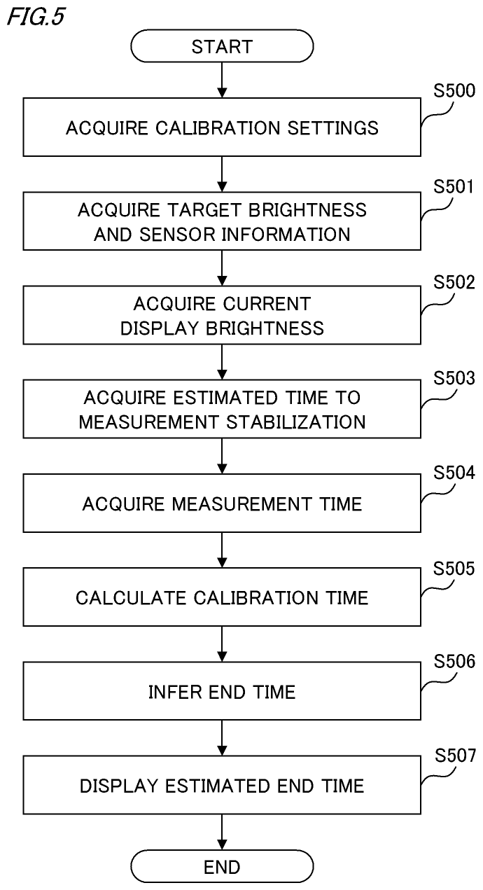

Light amount measurement processing according to the second embodiment will be described below with reference to FIGS. 1 and 5. FIG. 5 is a flowchart showing an example of the light amount measurement processing according to the second embodiment. In S500, the control unit 106 acquires the calibration settings input by the user. The calibration settings include the target brightness of the calibration and the sensor information.

In S501, the control unit 106 acquires the target brightness of the calibration and the sensor information. In the example of FIG. 5, the target brightness is 2000 nit, and the sensor information denotes a spectroscopic sensor.

In S502, the control unit 106 acquires the current display brightness, which is set in the image quality settings input by the user. In the example of FIG. 5, the display brightness is set at 100 nit.

In S503, the control unit 106 acquires the estimated time to measurement stabilization by referring to the stabilization time table 304 in the storage unit 105. The control unit 106 can acquire an estimated time of 600 (s) to measurement stabilization from the target brightness (2000 nit) acquired in S501 and the display brightness (100 nit) acquired in S502.

In S504, the control unit 106 acquires the measurement time by referring to the measurement time table 303 in the storage unit 105. The control unit 106 can acquire a measurement time of 400 (s) from the target brightness (2000 nit) and the sensor information (spectroscopic) acquired in S501.

In S505, the control unit 106 calculates the time for calibration. The control unit 106 calculates the calibration time as follows from the estimated time acquired in S503 and the measurement time acquired in S504.

calibration time=estimated time to measurement stabilization (600 s)+measurement time (400 s)=1000 (s)

In S506, the control unit 106 infers the estimated end time of calibration. The control unit 106 infers the estimated end time as follows by acquiring the current time and adding the calibration time calculated in S505 thereto.

estimated calibration end time=current time+calibration time

In S507, the control unit 106 outputs the estimated end time of calibration, inferred in S506, to the display unit 102 together with a banner to be displayed at the start of calibration. The display unit 102 displays the time output by the control unit 106 together with the banner.

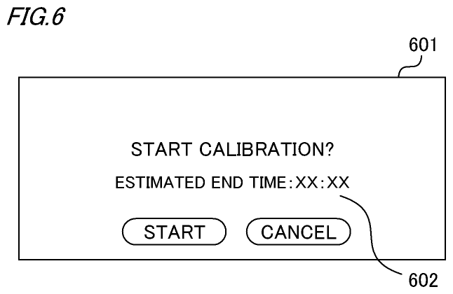

Referring to FIG. 6, the banner displayed by the display unit 102 will be described. FIG. 6 shows an example display of the estimated calibration end time. A banner 601 displays an estimated end time 602 together with calibration start guidance. The estimated calibration end time may vary according to the environment in which calibration is performed and may therefore be expressed so as to include an error, for example estimated end time t XX.

The estimated end time 602 is not limited to being displayed on the banner 601 before the start of calibration, as shown in FIG. 6. When a progress banner is provided on a calibration GUI, the estimated end time 602 may be displayed in a position adjacent to the progress banner or in the margin of the calibration GUI while calibration is underway.

To improve the precision of the estimated calibration end time, the display unit 102 or the light source unit 103 may be installed with a temperature sensor, and the control unit 106 may calculate the calibration time on the basis of information from the temperature sensor. Further, the control unit 106 may calculate the calibration time by also taking into account setting information included in the calibration settings, such as the color temperature and local dimming.

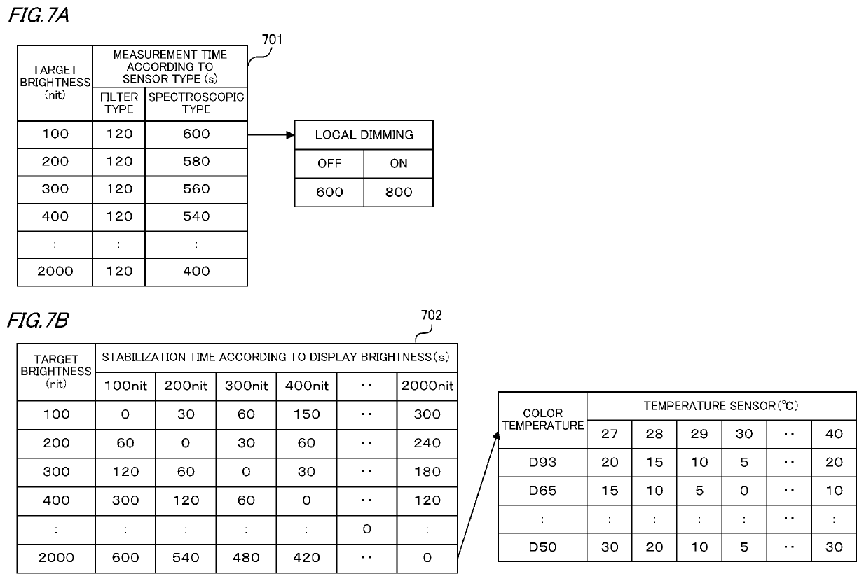

Referring to FIGS. 7A and 7B, an example in which the calibration time is inferred by also taking into account setting information such as the color temperature or local dimming will be described. FIGS. 7A and 7B are views illustrating data stored in the storage unit 105 according to the second embodiment.

FIG. 7A is a measurement time table 701 on which the measurement time by the light reception unit 104 in accordance with the sensor type is subdivided in accordance with the local dimming setting. On the measurement time table 701, when the target brightness is 100 nit and the sensor is a spectroscopic sensor, different measurement times are set in accordance with whether local dimming is ON or OFF. More specifically, the measurement time in a case where the target brightness is 100 nit and the sensor is a spectroscopic sensor is 600 s when local dimming is ON and 800 s when local dimming is OFF.

FIG. 7B is a stabilization time table 702 on which the estimated time to measurement stabilization corresponding to the display brightness is subdivided in accordance with the color temperature setting. On the stabilization time table 702, when the target brightness and the display brightness are both 2000 nit, the estimated time to measurement stabilization is subdivided in accordance with the color temperature and current information from the temperature sensor.

According to the light amount measurement device 10 described above, the user can ascertain the estimated end time of calibration either at the start of calibration or during calibration. As a result, the user can omit an aging action (keeping a monitor in a display state for a fixed time until the display on the monitor stabilizes after switching the power supply of the monitor ON) prior to calibration.

### Third Embodiment

In the method for shortening the color measurement time by increasing the light source brightness, a problem exists in that the temperature of the light source increases. When the temperature of the light source itself (referred to hereafter as the light source temperature) increases, in a typical light source, the emission lighting intensity varies. For example, when the light source is an LED, the emission lighting intensity decreases in response to temperature increases. During measurement for the purpose of calibration, unintended variation in the emission lighting intensity may lead to a reduction in the precision of the calibration.

Hence, in a light amount measurement device according to a third embodiment, lighting of the light source is controlled in order to reduce variation in the light source temperature while shortening the color measurement time at low brightness.

### Device Configuration

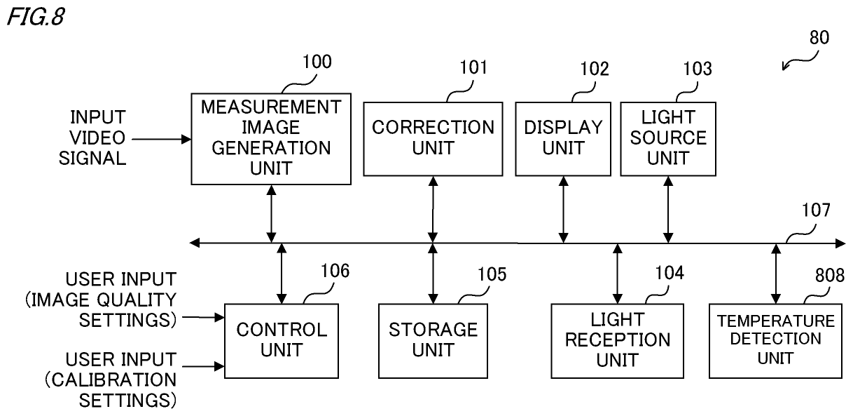

FIG. 8 is a block diagram showing an example configuration of the light amount measurement device according to the third embodiment. Similar configurations to those of the light amount measurement device 10 shown in FIG. 1 have been allocated identical reference numerals, and duplicate description thereof has been omitted.

A light amount measurement device 80 according to the third embodiment includes, in addition to similar configurations to those of the light amount measurement device 10 shown in FIG. 1, a temperature detection unit 808. The temperature detection unit 808 detects the temperature of the light source unit 103. During measurement for the purpose of calibration, the storage unit 105 stores, in addition to the data shown in FIGS. 3A to 3D, information indicating the temperature (referred to hereafter as the light source unit temperature) detected by the temperature detection unit 808 during display at each gradation. The stored information relating to the light source unit temperature can be referred to by units such as the control unit 106.

### Reducing Light Source Temperature Variation

Here, a method for reducing light source temperature variation will be described. The light source is disposed in the light source unit 103, and the light source temperature is a temperature acquired by adding heat generated when the light source is lit to the temperature of a substrate. The light source temperature and the light source unit temperature satisfy the following relationship.

light source temperature=light source unit temperature+light source heat generation

The light source unit temperature is a temperature measured by the temperature detection unit 808, for example a temperature sensor such as a thermistor disposed on the substrate on which the light source is disposed. At an Nth gradation, the light source unit temperature when measurement is performed at a high brightness is set as TaN 1 [° C.], and the light source unit temperature when measurement is performed without increasing the brightness is set as TaN 0 [° C.].

Light source heat generation can be determined from a product of a relationship between a forward voltage Vf [V] and a forward current If [A], which are properties of the light source device, and a thermal resistance value Rθja [° C./W]. In order to shorten the measurement time, the forward voltage and the forward current in a case where the brightness (also referred to hereafter as the light source unit brightness) of the light source unit 103 during low gradation display is measured at a high brightness are set respectively as Vf1 and If1, while the forward voltage and the forward current in a case where the light source unit brightness is measured without increasing the brightness are set respectively as Vf0 and If0.

In this case, temperature variation in the light source unit temperature and temperature variation caused by light source heat generation can be expressed as follows.

temperature variation in light source unit temperature: Δ TaN 1(=TaN 1−TaN 0) [° C.]

temperature variation caused by light source heat generation: (Vf1/Vf0)×(If1/If0)×Rθja

During measurement at a high brightness, temperature variation caused by light source heat generation is suppressed by reducing the forward current If1 supplied while the light source is lit. By controlling the forward current If1 during measurement at a high brightness so that the sum of the temperature variation in the light source unit temperature and the temperature variation caused by light source heat generation reaches zero, variation between the light source temperature in a case where measurement is performed at a high brightness and the light source temperature in a case where measurement is performed without increasing the brightness is reduced at each gradation.

In the description of this embodiment, as regards the relationship between the properties Vf and If of the light source device, it is assumed that regardless of If, Vf=3.0 V and the thermal resistance value Rθja=30 [° C./W]. It is also assumed that variation in the forward current If of the light source and the emission brightness have a proportional relationship with a constant of 1, and that variation in the PWM value of the light source and the emission brightness have a proportional relationship with a constant of 1.

### Light Amount Measurement Processing

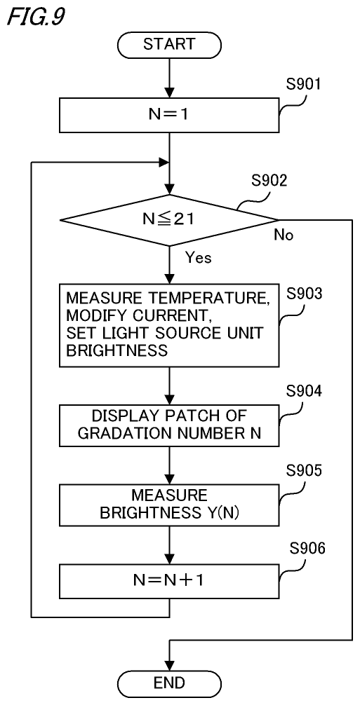

Referring to FIG. 9, a specific method for reducing variation in the light source temperature will be described. FIG. 9 is a flowchart showing an example of light amount measurement processing according to the third embodiment. In the third embodiment, in order to shorten the measurement time in a case where the light source unit brightness during low-gradation display is measured at a high brightness, the light amount measurement device 80 reduces the light source temperature so as to bring the light source temperature closer to the light source temperature in a case where measurement is performed without increasing the brightness.

First, a loop structure relating to the measurement gradation number N in the flowchart of FIG. 9 will be described. In S901, S902, and S906, the control unit 106 determines whether or not measurement at each measurement gradation number N is complete.

In S901, the control unit 106 sets the measurement gradation number N at 1. In S903 to S906, the light source unit brightness at the first gradation is measured. In S902, the control unit 106 determines whether or not measurement up to the 21st gradation is complete. In a case where N is not larger than 21, the control unit 106 performs measurement from S903 to S906. In a case where N is larger than 21, the processing shown in FIG. 9 is terminated.

In S906, the control unit 106 sets N at N+1 in order to measure the next gradation. After performing measurements from the 1st to the 21st gradation, the control unit 106 terminates the light amount measurement processing shown in FIG. 9.

Next, the processing executed from S903 to S906 within the loop will be described. In S903 to S906, the control unit 106 displays the measurement image of each gradation on the display unit 102 and measures the brightness thereof.

In S903, the control unit 106 measures the light source unit temperature TaN 1 [° C.] during high-brightness display at the Nth gradation. The control unit 106 acquires the light source unit temperature [° C.] detected during measurement without increasing the brightness (in other words, when the light source unit brightness is a multiple of 1) from the storage unit 105. The control unit 106 then calculates the current If1 [A] to be supplied to the light source so that the temperature difference between TaN 1 and TaN 0 becomes zero. In a case where measurement is to be performed at a high brightness, the control unit 106 modifies the current supplied while the light source is lit to the calculated supply current If1.

More specifically, the control unit 106 calculates a differential temperature Δ TaN 1 [° C.]. Further, the control unit 106 calculates If, which is a current difference for canceling out ATaN 1 (reducing ATaN 1 to zero), at Δ TaN 1=−(Vf′×If′× Rθja). If the current supplied to the light source during measurement at TaN 0 [° C.] is set as If0 [A], the control unit 106 can calculate If1 (If1=If0+If′) [A]. The control unit 106 can then set the current to be supplied to the light source at If1 [A] and increase the lighting time (the PWM value) per lighting cycle so that the envisaged reduction in brightness caused by the difference between If0 [A] and If1 [A] does not occur.

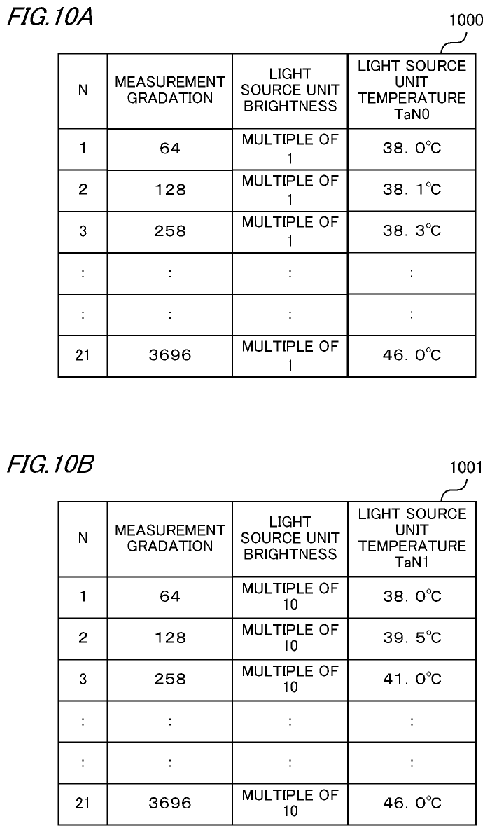

Referring to FIGS. 10A and 10B, a specific method for modifying the current supplied to the light source will be described. FIG. 10A is a temperature table 1000 showing light source unit temperatures TaN 0 at the measurement gradation numbers N in a case where the light source unit brightness is a multiple of 1. The temperature table 1000 stores information about light source unit temperatures TaN 0 measured in advance. FIG. 10B is a temperature table 1001 showing light source unit temperatures TaN 1 at the measurement gradation numbers N in a case where the light source unit brightness at a low gradation is increased to a multiple of 10.

A case in which the current supplied to the light source is modified at the 3rd gradation will be described below. First, the difference in the light source unit temperature (ATaN 1) is calculated. The temperature detection unit 808 detects the light source unit temperature TaN 1 prior to measurement at the 3rd gradation. It is assumed that TaN 1 is 41.0° C. The detected temperature is stored on the temperature table 1001.

The control unit 106 acquires the temperature TaN 0 at the time of measurement at the 3rd gradation from the temperature table 1000 stored in the storage unit 105. The temperature table 1000 shows that when the 3rd gradation is displayed, the measurement gradation is 258, the light source unit brightness is a multiple of 1, and the light source unit temperature is 38.3° C. At the 3rd gradation, the light source unit temperature TaN 0 in a case where measurement is performed with the light source unit brightness at a multiple of 1 is 38.3° C., and therefore the differential temperature Δ TaN 1 is calculated at Δ TaN 1=41.0° C.-38.3° C.=2.7° C.

Next, the current difference If′ for canceling out of the differential temperature Δ TaN 1 is calculated. An example in which the forward current during measurement at TaN 0 is If0=0.08 [A], the PWM value is 10/1000, and the light source unit brightness during measurement at TaN 1 is set at a multiple of 10 will be described. Note that a PWM value a/b means that the light source is lit for a period of a over a period of b. The current difference If′ is calculated at If′=−(Δ TaN 1)/(Vf′×Rθja)=−2.7° C./(3.0 V×30° C./W)=−0.03 [A].

Hence, the current If1 supplied to the light source when measurement is performed at a high brightness is calculated at If1=If0+If′=0.08 A−0.03 A=0.05 [A]. Further, in order to set the light source unit brightness at a multiple of 10, the PWM value of the light source is set at 100/1000 in a case where the current is not varied. However, to compensate for brightness variation of a multiple of 5/8, which occurs as a result of the current variation If1/If0=0.05 A/0.08 A, the PWM value is set at a multiple of 8/5 (a multiple of 1.6). The final PWM value is calculated at 160/1000.

Accordingly, the control unit 106 controls the light source unit 103 to light the light source at settings of If1=0.05 [A] and PWM value=160/1000, rather than If1=0.08 [A] and PWM value=100/1000.

In S904, the control unit 106 sets the gradation of the liquid crystal panel at the gradation value of the measurement gradation number N in order to perform gradation display with the light source unit brightness in an increased state. For example, when N=3, the transmittance of the display unit 102 is set at a gradation of 258. In other words, a patch with a gradation value of 258 is displayed on the display unit 102.

In S905, the light reception unit 104 measures the brightness Y(N) of transmission through the liquid crystal panel. For example, as shown in FIG. 10B, when the measurement gradation number N=3, the light source is lit so that the light source unit brightness reaches a multiple of 10, and therefore the light amount increases to a multiple of 10. Hence, the control unit 106 can calculate the measurement brightness in a case where the light source unit brightness is set at a multiple of 1 by performing a correction in which the inverse 1/10 of the increase rate of the light amount is integrated with the measurement result.

As described above, the light amount measurement device 80 increases and measures the light source unit brightness during low-gradation measurement, and modifies the forward current to be supplied to the light source on the basis of variation in the light source unit temperature. In so doing, the light amount measurement device 80 can shorten the color measurement time at low brightness and bring the light source temperature closer to the light source temperature in a case where measurement is performed without increasing the brightness. Thus, the amount of variation in the light source temperature decreases, and as a result, the light amount measurement device 80 can reduce a measurement error accompanying brightness variation.

Note that in the above example, in S905, the control unit 106 only compensates for the brightness in response to variation in the forward current from If0 to If1, but the present invention is not limited thereto. In a case where variation occurs in optical characteristics (luminous flux, light distribution, illuminance, and so on, for example) of the light source after the forward current is varied, the control unit 106 can further improve the precision of brightness measurement by compensating for the variation in the optical characteristics from the measurement result.

Further, in S903, the forward voltage Vf of the light source is described as remaining constant regardless of the forward current If of the light source, but the present invention is not limited thereto. For example, the control unit 106 can precisely manage the temperature of the light source by reflecting the voltage difference Vf appropriately when the forward voltage Vf varies.

### Modified Example 1

In the method described in the third embodiment, lighting of the light source is controlled in S903 by varying the forward current and the PWM value in a case where measurement is performed at a high brightness and at the Nth gradation. In modified example 1 of the third embodiment, meanwhile, the light amount measurement device 80 suppresses an increase in the light source temperature and reduces the measurement error by controlling the lighting cycle of the light source to be short while maintaining the lighting time thereof.

First, the mechanism by which the light source temperature increases will be described. In the description of S903, the relationship between variation in the PWM value of the light source and the emission brightness was described as a proportional relationship with a constant of 1. However, a characteristic of PWM lighting of an actual light source is that due to the responsiveness of the power supply and peripheral circuits, a strictly square wave is not acquired. More specifically, when control is performed to extinguish the light source by lowering the PWM momentarily after the light source is lit, the control is greatly affected by the responsiveness to the lighting or extinguishing instructions, and as a result, the relationship between variation in the PWM value of the light source and the emission brightness becomes a proportional relationship with a constant larger than 1. Accordingly, a problem occurs in that when the light amount increases, the light source temperature also increases. In response to this problem, the light amount measurement device 80 controls the lighting cycle of the light source serving as light emitting means in S903 to be short while maintaining the lighting time thereof.

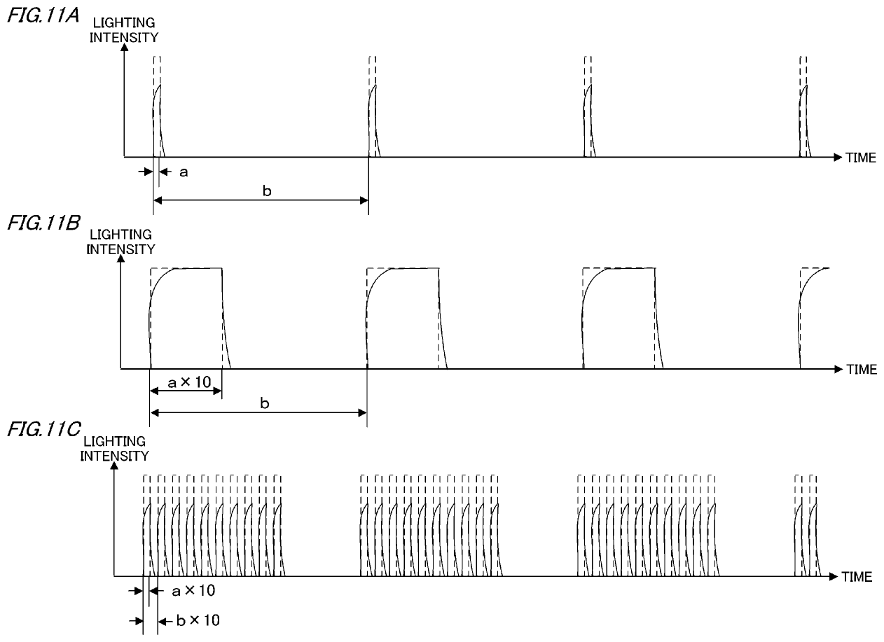

Referring to FIGS. 11A to 11C, control for shortening the lighting cycle will be described. FIGS. 11A to 11C are views illustrating the relationship between the lighting time a and the lighting cycle b and the effect of the responsiveness.

FIG. 11A shows an example in which the PWM value is a/b. Rectangles indicated by dotted lines denote ideal lighting. It is evident that due to the effect of the responsiveness, the amount of emitted light is insufficient, with the result that the ideal lighting intensity is not reached during the lighting time a.

FIG. 11B shows an example in which the lighting time a of the PWM value is set at a multiple of 10 in order to set the lighting time at a multiple of 10. In FIG. 111B, the PWM value is 10 times that of FIG. 11A. Since lighting and extinguishing are not performed repeatedly, the effect of the responsiveness is smaller than in FIG. 11A. The light amount approaches the ideal lighting intensity indicated by the dotted lines, becoming at least 10 times greater than that of FIG. 11A.

FIG. 11C shows an example in which the lighting time (duty ratio) is set at a multiple of 10 by shortening the lighting cycle b while maintaining the lighting time a. Since lighting and extinguishing are performed repeatedly, a similar responsiveness to that of the example shown in FIG. 11A is maintained. Accordingly, the light amount becomes approximately 10 times that of FIG. 11A, while excessive increases in the light source temperature are suppressed.

In modified example 1 of the third embodiment, control is performed in S903 to shorten the lighting cycle of the light source while maintaining the lighting time thereof within the lighting cycle. As a result, errors caused by temperature increases are reduced while ensuring that excessive increases in brightness due to the responsiveness do not occur.

### Modified Example 2

In the third embodiment, the light amount measurement device 80, when increasing the light source unit brightness, performs control to bring the light source temperature close to the light source temperature prior to the increase in the light source unit brightness by modifying the amount of current supplied to the light source or increasing the lighting time of the light source.

In modified example 2 of the third embodiment, meanwhile, the light amount measurement device 80 performs control to increase the light amount of the light source while measurement by the light reception unit 104 serving as light receiving means is underway. In so doing, the light amount measurement device 80 can eliminate unnecessary light emission and bring the light source temperature close to the light source temperature prior to the increase in the light source unit brightness.

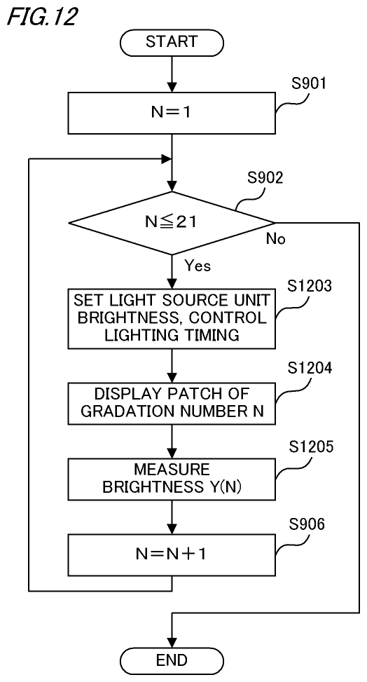

Referring to FIG. 12, control for increasing the light amount of the light source during measurement by the light reception unit 104 will be described. FIG. 12 is a flowchart showing an example of light amount measurement processing according to modified example 2 of the third embodiment. Similar processing to that of FIG. 9 has been allocated identical reference symbols, and description thereof has been omitted. Parts of the processing that differ from the flowchart of FIG. 9 will be described.

In S1203, in contrast to S903, the control unit 106 performs control to light the light source during the measurement period of the light reception unit 104 without modifying the current on the basis of the temperature measurement.

In S1204, the control unit 106 displays the patch of the measurement gradation number N on the display unit 102 during the measurement period of the light reception unit 104. S1204 differs from the processing of S904 in that control is performed to display the patch during the measurement period of the light reception unit 104.

In S1205, the control unit 106 controls the light source unit 103, the display unit 102, or both thereof so that the patch of the measurement gradation number N is not displayed on the display unit 102 either immediately after the start of measurement or at the end of measurement. S1205 differs from the processing of S905 in that this control is performed.

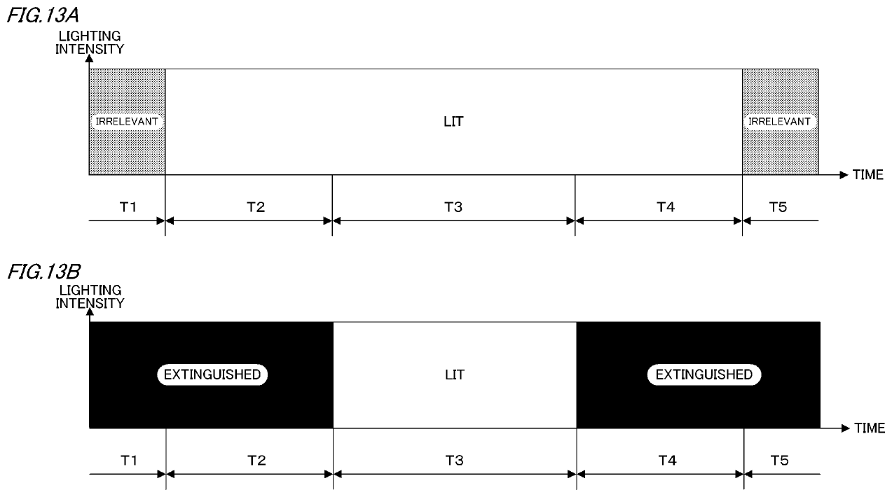

Referring to FIGS. 13A and 13B, the specific differences between the processing of S1203 to S1205 and the processing of S903 to S905 will be described. FIGS. 13A and 13B are views illustrating a relationship between lighting of the light source and the measurement time.

FIG. 13A shows an example in which the brightness of the light source is increased (the light amount of the light source is increased) and the light reception unit 104 measures the brightness during the period in which the patch of the measurement gradation is displayed. During periods T1 and T5, lighting control of the light source and control of the display unit 102 is set as irrelevant (arbitrary). Further, during a period from T2 to T4, the control unit 106 lights the light source and displays the patch on the display unit 102. During a period T3, the light reception unit 104 implements brightness measurement.

During the period from T2 to T4, the measurement time taken by the light reception unit 104 is shortened by increasing the brightness of the light source. By shortening the measurement time, unnecessary light emission is eliminated, and as a result, the light source temperature is reduced so as to approach the light source temperature prior to the increase in the light source unit brightness. Note that during T1 and T5, in which the light reception unit 104 does not measure the brightness, control may be performed so that the brightness of the light source is not increased (so that the light amount of the light source is not increased). By performing this control, increases in the light source temperature are suppressed.

FIG. 13B shows an example in which the light source is lit only during the measurement period of the light reception unit 104. The control unit 106 extinguishes the light source during the periods T1, T2, T4, and T5, and the display unit 102 is shielded. Further, during the period T3, the control unit 106 lights the light source by increasing the brightness thereof, and the patch is displayed on the display unit 102. The light reception unit 104 implements measurement so as to include the period T3. FIG. 13B differs from FIG. 13A in that the light source is extinguished in at least the periods T2 and T4.

In modified example 2 of the third embodiment, the control unit 106 controls the light source, the display unit 102, and the light reception unit 104 during the measurement period in order to suppress unnecessary lighting time, and as a result, the light source temperature can be brought closer to the temperature thereof during measurement in which the light source brightness is not increased.

Here, shortening of the measurement time in a case where the light source unit brightness is measured after being increased will be described. In a case where the light amounts emitted during the lighting periods of FIGS. 13A and 13B are identical, in FIG. 13B, the brightness decreases in proportion to the lighting time. By increasing the light amount of the light source in inverse proportion to the lighting time, the control unit 106 can measure the brightness prior to the increase in the light source unit brightness by lighting the light source for a short time. In other words, since the light amount and the lighting time are inversely related, the brightness prior to the increase in the light source unit brightness can be converted to brightness prior to increase in light source unit brightness=measured brightness/brightness increase rate. Thus, the measurement time is shortened in accordance with increases in the light amount of the light source, and heat generation by the light source unit 103 is also suppressed.

Preferred embodiments of the present invention were described above. However, the present invention is not limited to these embodiments, and within the scope of the spirit thereof, various amendments, modifications, and combinations are possible.

According to the present invention, the measurement time at low brightness can be shortened during calibration processing of a display device.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-068474, filed on Apr. 6, 2020, which is hereby incorporated by reference herein in its entirety.

What is claimed is:

1. A light amount measurement device comprising at least one memory and at least one processor which function as:
a light source unit including a light source;
a display unit including a transmissive panel that transmits light emitted from the light source;
a light reception unit configured to measure an amount of light that has passed through the display unit; and
a control unit configured to control, during calibration of the display unit, a brightness measured by the light reception unit to a higher brightness than an ideal brightness corresponding to a measurement gradation, by either increasing the light amount emitted by the light source or increasing a transmittance of the display unit.

2. The light amount measurement device according to claim 1, wherein, in a case where the light reception unit measures the brightness at a plurality of measurement gradations, the control unit either fixes the light amount of the light source at a light amount emitted at a maximum measurement gradation, or fixes the transmittance of the display unit at a transmittance realized at the maximum measurement gradation.

3. The light amount measurement device according to claim 1, wherein, in a case where the light reception unit measures the brightness at a plurality of measurement gradations, the control unit does not perform measurements at measurement gradations at which a deviation between the brightness measured by the light reception unit and the ideal brightness is not larger than a predetermined threshold.

4. The light amount measurement device according to claim 1, wherein the control unit controls the brightness measured by the light reception unit to a higher brightness than the ideal brightness in a case where at least any of the ideal brightness, an actual brightness, and the measurement gradation is not higher than a predetermined threshold.

5. The light amount measurement device according to claim 1, wherein
the ideal brightness is a brightness corresponding to a target value of the calibration, and
target values of the calibration include target values of brightness, gamma, color temperature, color gamut, local dimming, and sensor type.

6. The light amount measurement device according to claim 1, wherein the control unit displays an estimated end time of the calibration on the display unit at least either at the start of the calibration or while the calibration is underway on the basis of a measurement time by a sensor and a stabilization time for the display on the display unit and light emission by the light source to stabilize in a case of switching from a current display brightness to a target brightness.

7. The light amount measurement device according to claim 1, wherein the control unit converts the brightness measured by the light reception unit into a brightness measured without increasing the light amount of the light source and the transmittance of the display unit in accordance with whether measurement has been performed by increasing the light amount of the light source or by increasing the transmittance of the display unit, and generates a correction table from a difference between the converted brightness and the corresponding ideal brightness.

8. The light amount measurement device according to claim 1, wherein, in a case where the light reception unit performs measurement after the light amount of the light source has been increased, the control unit performs first control to reduce temperature variation in the light source.

9. The light amount measurement device according to claim 8, wherein, while measurement by the light reception unit is not underway, the control unit performs second control such that the light amount of the light source is not increased.

10. The light amount measurement device according to claim 8, wherein the at least one memory and the at least one processor further function as a temperature detection unit for detecting the temperature of the light source unit, wherein
the control unit performs the first control such that the temperature of the light source unit, detected by the temperature detection unit, is brought close to the temperature of the light source unit in a case where the light amount of the light source is not increased.

11. The light amount measurement device according to claim 8, wherein the first control is control for lengthening a lighting time of the light source during a lighting cycle thereof and reducing a current supplied while the light source is lit.

12. The light amount measurement device according to claim 8, wherein the first control is control for shortening a lighting cycle of the light source while maintaining a lighting time thereof.

13. The light amount measurement device according to claim 8, wherein the control unit increases the light amount of the light source during measurement by the light reception unit.

14. The light amount measurement device according to claim 8, wherein the control unit varies the light amount of the light source in inverse proportion to the lighting time.

15. A control method for a light amount measurement device that includes a light source unit including a light source and a display unit including a transmissive panel that transmits light emitted from the light source, the control method comprising:
a light reception step for measuring an amount of light that has passed through the display unit; and
a control step of controlling, during calibration of the display unit, a brightness measured in the light reception step to a higher brightness than an ideal brightness corresponding to a measurement gradation, by either increasing the light amount emitted by the light source or increasing a transmittance of the display unit.

16. A non-transitory computer readable medium that stores a program, w % herein the program causes a light amount measurement device, which includes a light source unit including a light source and a display unit including a transmissive panel that transmits light emitted from the light source, to execute:
a light reception step for measuring an amount of light that has passed through the display unit; and
a control step of controlling, during calibration of the display unit, a brightness measured in the light reception step to a higher brightness than an ideal brightness corresponding to a measurement gradation, by either increasing the light amount emitted by the light source or increasing a transmittance of the display unit.
